(19) United States
(12) Patent Application Publication
(10) Pub. No.: US 2009/0142538 A1
(43) Pub. Date: Jun. 4, 2009

(54) CORROSION RESISTANT PRECOATED LAMINATED STEEL

(75) Inventors: David R. Sigler, Shelby Township, MI (US); Xiaohong Q. Gayden, West Bloomfield, MI (US); Xiaorong Jin, Rochester Hills, MI (US); Robert B. Ruokolainen, Livonia, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM GLOBAL TECHNOLOGY OPERATIONS, INC., Detroit, MI (US)

(21) Appl. No.: 12/134,392

(22) Filed: Jun. 6, 2008

Related U.S. Application Data
(60) Provisional application No. 60/942,782, filed on Jun. 8, 2007.

(51) Int. Cl. B32B 15/092

(52) U.S. Cl. 428/76

(57) ABSTRACT

Two steel sheets joined face-to-face with a core layer form a laminated workpiece that may be shaped, for example, into automotive components. Depending on the nature of the core layer the laminated workpieces may be used for sound and vibration damping or as light weight structural panels. Before joining of the steel sheets, their facing surfaces may each be provided with a polymeric (organic or inorganic) corrosion resistant film that resists physical degradation such as tearing or scratching as the laminate is formed into a desired component shape. The pre-applied protective layer may also provide a bonding layer for the viscoelastic core or a structural core material. Conductive particles may be incorporated into the viscoelastic layer to assist in electrical resistance welding involving the laminated steel workpiece.

This application claims priority based on provisional application 60/942,782, titled “Corrosion Resistant Precoated Laminated Steel,” filed Jun. 8, 2007 and which is incorporated herein by reference.

### TECHNICAL FIELD

This invention pertains to improvements in sandwich structures of two steel sheets bonded face-to-face with a core layer. In one embodiment the core layer is a coextensive polymeric vibration-damping (viscoelastic) adhesive of uniform thickness. In another embodiment the core layer may be a bonded fibrous material or a non-fibrous polymer layer. These layered products are known as laminated steel and they are manufactured for use as sheet components in automotive vehicles as (i) vibration and sound damping members and/or as (ii) light weight structural members. More specifically, this invention pertains to laminated steel structures in which the facing surfaces of the steel sheets are coated with a strongly adherent corrosion resistant polymeric (organic or inorganic) layer before bonding with the core layer material.

### BACKGROUND OF THE INVENTION

Vibration damping steel sheets are stamped or otherwise formed into automotive components such as vehicle front of dash, plenum, partition panels, oil pans, and the like. These light weight damping members serve to reduce transmission of airborne and structure born noise to the passenger compartment. The vibration damping material is a laminated structure including two coextensive thin steel sheets that are bonded in a sandwich structure with a viscoelastic polymer core. The steel sheets provide strength and formability to the laminate and the viscoelastic core material damps sound vibrations. By way of example, the sheets may be of low carbon steel, each with a thickness of about 0.5 millimeter, and the core resin a suitable viscoelastic thermoplastic or thermoset polymer having a thickness of about 30 micrometers. The total thickness of the laminated steel material is often in the range of about 0.9 to 1.5 millimeters.

In these automotive vehicle applications, the laminated workpieces sometimes have corrosion protection on the steel sheet members consisting of an electrogalvanized or hot dip zinc coating on the exterior surfaces of the laminated sheets (described as two-side galvanized). In other workpieces, both the exterior and interior surfaces of both steel sheets are galvanized (four-side galvanized). Typical coating weights for automotive applications are about 60 g/m². Thus, a four-side galvanized steel laminate comprises two fully galvanized steel skins and a viscoelastic polymer core.

Two-side galvanized steel laminates may show corrosion on the internal surfaces of the facing sheets from ingress of moisture possibly containing salt into the core of the laminate. This moisture ingress is exacerbated by delamination of the laminate that can occur from a number of manufacturing operations in which it is employed. The laminates must often be formed and/or spot welded and these operations may cause delamination of the layered workpiece. Sometimes delamination occurs when the laminates are painted and baked. Four-side galvanized laminate improves corrosion protection by applying a Zn coating to the interior surfaces that helps control corrosion on the internal surfaces. However, even with internal Zn coatings the steel laminate sometimes fails to meet long-term corrosion objectives for many automotive vehicle applications.

There is a related class of laminated steel workpieces that are composed more for lightweight strength. They comprise two steel sheet layers with a light weight core material. The steel layers may be bare or coated with zinc. But when they are used in automotive body applications they are also susceptible to corrosion on the inner faces of the steel sheets.

### SUMMARY OF THE INVENTION

In one embodiment of the invention a laminated steel material is provided comprising two steel sheets of substantially the same shape lying face-to-face and edge-to-edge. The facing sheets will sometimes be referred to as the skin layers of the laminate. The facing surfaces of each of the sheets are coated coextensively with an adherent, tough corrosion-resistant layer that is resistant to environmental corrosion, for example from salt water. Toughness of the corrosion resistant layer is desired to resist chipping or tearing of the coating film. The corrosion-resistant layer may be of a suitable organic polymeric composition or an inorganic film forming composition that provides corrosion protection and a base for an intended core layer. When a steel laminate embodiment is intended largely for a vibration damping application, the corrosion-resistant layer coated sheets are bonded together with a coextensive core layer of viscoelastic material that provides sound or vibration damping properties to the laminate. When the steel laminate embodiment is intended largely for a structural application without particular need for vibration damping, the core material is selected for a combination of strength and relatively low weight.

A vibration damping embodiment of the invention first will be described. By way of example and not of limitation, the thicknesses of the steel sheets is often in the range of about one-half millimeter to one millimeter, the thicknesses of the corrosion resistant polymeric layers are in the range of about 0.5 to 50 micrometers, and the thickness of the viscoelastic core layer is in the range of about 5 to about 200 micrometers.

Also, by way of example, the corrosion resistant layer may be composed of an epoxy composition or mixtures or copolymers of epoxy materials with polyamide materials or phenolic materials or polyurethane materials. Particles may be incorporated in the polymer layer that are anodic to the steel sheets and help prevent corrosion of the steel in automotive applications. Examples of suitable inorganic particles include zinc powder, zinc phosphate compositions, magnesium and/or calcium phosphates and phosphites with suitable cation constituents. An inorganic polymeric coating may be used as the corrosion resistant layer. For example, polymeric silicate coatings, initially deposited as, for example, ethyl orthosilicates, may be mixed with zinc dust, or the like, and precoated on the facing surfaces of the steel sheets.

Different families of viscoelastic core materials are known and commercially available. Some of the core materials are based on elastomer compositions such as styrene-butadiene rubber (SBR), and styrene-ethylene/butylene-styrene terpolymer (SEBS). Some are based on acrylic copolymers such as acrylic acid ester copolymer, styrene-acrylic copolymer, or its polymer blends with styrene-butadiene. Some core materials are based on polyvinyl acetate (VA), or its copolymers such as ethylene vinyl acetate copolymer or ethylene-vinyl acetate-maleic anhydride terpolymer. And some core materials are based on epoxy based block copolymer such as epoxy polyester block copolymer or epoxy polyether block copolymer. The corrosion resistant layer of the laminate and the viscoelastic core need to be chemically compatible and the core layer needs to adhere to the preformed corrosion resistant layer.

In applications where the steel laminate is to be subjected to spot welding or other forms of electrical resistance welding it may be useful to incorporate electrically conductive particles in the viscoelastic core layer so as to enhance conductivity between the steel sheets. Examples of suitable electrically conductive particles include particles of iron, iron phosphide, stainless steel, copper, and nickel.

Where the steel laminate is to be used largely as a light weight structural workpiece the steel sheet materials and the core material may differ from the vibration damping embodiment, but the facing surfaces of the steel sheet materials are protected with corrosion resistant coatings as described above. Structural laminates are typically formed of steel skin sheets with cores comprising one or more of paper fibers, polymer fibers, or bulk polymers. The core and skins are usually bonded together with ordinary adhesives. Core thicknesses may be from about 0.2 mm up to about 2 mm.

Steel skin layers may be formed, for example, of cold rolled low carbon steel, high strength low alloy steel, bake hardening steel, dual phase steel, or transformation induced plasticity steel. Each steel sheet of the laminate usually has the same thickness and, depending on strength requirements, is typically in the range from 0.10 mm to 1.5 mm. In accordance with this invention, the inside steel faces are pre-coated with a corrosion resistant layer as described above. If necessary, an adhesive may be used to bond the coated steel skin layer to the core material.

In either the vibration damping embodiment or the structural embodiment, the steel sheets of laminated product may have zinc galvanized layers on one or both sides of their surfaces.

Other objects and advantages of the invention will be apparent from a detailed description of certain preferred embodiments of the invention.

### BRIEF DESCRIPTION OF THE DRAWINGS

FIG. 1 is a cross-sectional view of a small portion of a laminated steel workpiece having an adherent corrosion-resistant coating on each steel layer over the inner galvanized coating layer and facing the viscoelastic core. The corrosion-resistant layer is applied as a pre-coating to the side of the steel intended to face the core material.

FIG. 2 is a cross-sectional view of a small portion of a laminated steel workpiece, similar to FIG. 1, in which electrically conductive particles are incorporated within the viscoelastic core layer.

FIG. 3 is a cross-sectional view of a small portion of a laminated steel workpiece, similar to FIG. 1, in which electrically conductive particles are incorporated in one of the corrosion-resistant coating layers, the particles extending into the later applied viscoelastic core layers.

### DESCRIPTION OF PREFERRED EMBODIMENTS

Practices of the invention will first be illustrated with respect to vibration damping steel laminates. Many of the practices used with vibration damping laminates are applicable to the steel laminated designed and composed more for structural applications requiring higher strength.

Prior laminated steels include a layered core structure tailored to provide both damping performance and corrosion resistance. Such laminated steels often consist of two 2-side galvanized steel skins and a viscoelastic core. However, after being subjected to manufacturing operations such as forming, welding, and ELPO baking, the laminate can separate or delaminate. The separation can be adhesive, cohesive, or near surface cohesive. In most instances the core separates by adhesional failure leaving the metal surface exposed or near-surface cohesional failure leaving only a microscopic layer of adhesive on the metal surface. Either result provides little or no protection for the Zn-coating on the skin sheet. With the ingress of moisture, corrosion can begin that will shorten the life of the panel.

Corrosion tests on the interior surfaces of laminate skin materials have been performed following GM's 9540P corrosion test procedure for steel panels. The salt content of the corrosive solution was increased to 5% to accelerate the corrosion process. It was found that test specimens of commercial laminate skin sheet, approximately 0.55 mm thick and containing no internal zinc coating, perforated after 28 days exposure to the salt solution. By comparison, specimens of the same materials coated with 60 g/m² of zinc perforated after 42 and 49 days of exposure, nearly twice the life. Despite this improved performance, the zinc coated sheets will not give the desired life in vehicle service. It is desired to have such specimens survive six years before perforation in severe corrosive environments.

This invention provides corrosion resistant laminated steel workpieces designed to provide improved corrosion resistance in water and salt-containing environments encountered in automotive vehicle applications.

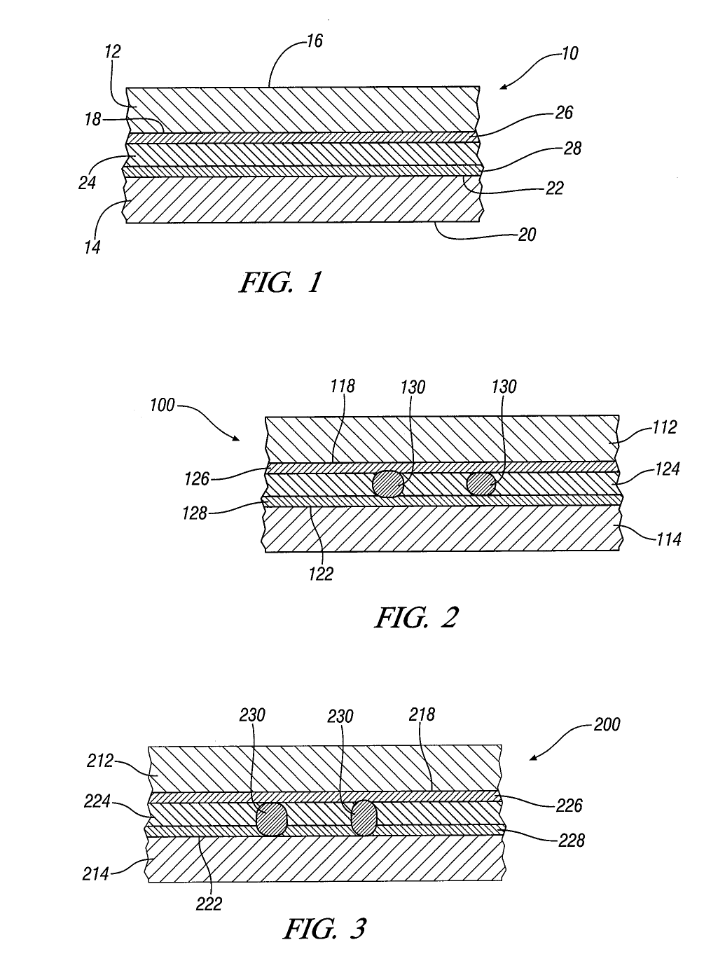

FIG. 1 shows a cross-sectional view of a representative portion of a steel laminate 10 formed in accordance with an embodiment of this invention. Steel laminate 10 comprises steel sheets 12, 14; corrosion resistant layers 26, 28; and viscoelastic core layer 24. In many embodiments, laminate 10 is prepared so that each layer is coextensive with the other layers and the peripheral edge of each layer forms a layer of the edges of a piece of the steel laminate. Long strips of the laminate 10 may be initially prepared at one location and shipped and stored in rolls at a manufacturing site at which pieces of the material are formed into products with sound damping properties. Workpiece size sections of desired size and shape may be cut from unrolled stock for forming into useful component shapes such as automotive front of dash, plenum, other partition panels, oil pans, and the like. The overall thickness of laminate 10 and the compositions of its respective layers are such that a workpiece of the laminate may be formed into predetermined shapes of such articles. The materials used in the respective layers of the laminate are important to the shaping and durability of the formed product, and the cross-sectional views of the drawing figures (FIGS. 1-3) are used to illustrate these compositional features.

Referring again to FIG. 1, steel sheet 12 has opposite faces 16 and 18 and sheet 14 has opposing faces 20 and 22. In many embodiments, the sheets will be formed of a predetermined steel composition, such as a low carbon steel, to provide the laminate with suitable formability and the formed product with suitable strength and other properties. In the embodiment illustrated in FIG. 1, the thicknesses of steel sheets 12 and 14 are illustrated as being about the same, but this is not a requirement of the invention. Typically the thicknesses of the respective steel sheets will be in the range of about one-half millimeter to about one millimeter.

In many applications of steel laminates both surfaces of both sheets 12, 14 will be provided with a thin layer of zinc composition (4-side zinc galvanized layers) with a thickness of about 9 microns or coating weight for each layer of about 60 g/m². But the zinc galvanized layers are optional in some product applications and are not shown in FIG. 1 so as to simplify the illustration of the multilayer steel laminate 10.

Surface 18 of steel sheet 12 is shown facing surface 22 of steel sheet 14 in steel laminate 10. Steel surface 18 has been precoated with an adherent and tough layer 26 of suitable corrosion resistant material, and steel surface 22 has been precoated with an adherent and tough layer 28 of like or similar corrosion resistant material. Precoated steel layers 12 and 14 are then joined with a suitable layer 24 of viscoelastic polymer based composition. Thus, in the embodiment illustrated in FIG. 1, laminate 10 comprises galvanized skin sheets 12, 14 that are precoated with toughened, strong, adherent polymer layers 26, 28 applied, respectively, to the steel laminate inner surfaces 18, 22, and finally laminated by a relatively weaker viscoelastic core layer 24 for damping.

In preparation of a steel laminate 10, a corrosion resistant layer of suitable polymeric composition (organic or inorganic) and thickness may be applied to a steel sheet while the precursor sheet is in strip form prior to laminating. Examples of suitable corrosion resistant coating materials include epoxy resins or epoxy/polyester, epoxy/polyamide, epoxy/phenolic, epoxy/polyurethane resin blends. Epoxy resins are adherent to steel surfaces and prevent moisture, salt and the like from reaching the internal steel face of the laminate. Epoxy resins are the polymeric reaction products of, for example, epichlorohydrin and diglycidyl ether of bisphenol-A (DGEBA), or epichlorohydrin and novolac precursors. The epoxy resin may be toughened by mixing the epoxy precursors with a rubber such as polybutadiene or acrylonitrile-butadiene copolymers. The epoxy system may contain additional anti-corrosion inhibitors such as zinc powder, zinc phosphate compositions, magnesium and calcium phosphates, and certain phosphites.

Inorganic protective coating may be formed by application of, for example, ethyl orthosilicate containing zinc dust and curing or drying of the silicate precursor. Such polymeric silicate formulations may be self-curing water-based compositions or solvent based compositions.

A variety of coating techniques could be used including roller coating, spray coating, curtain coating, metering rod coating, or air knife coating. To survive a forming operation on the steel laminate workpiece material and be effective as a corrosion deterrent, the corrosion-resistant precoat may be formulated of a tough, high ductility, high adhesive strength, durable polymer, such as a suitable one-part toughened epoxy. The combination of a relatively weak viscoelastic core material and strong, tough precoat composition will insure that if delamination occurs during manufacturing operations, separation will take place either within the viscoelastic core or at the core/precoat interface. This will leave the high strength, toughened precoat layer adhering tightly to the galvanized surfaces of the skin sheet to improve laminate corrosion resistance. Sections of the precoated steel may then be cut form the precursor sheet material and coated sides of the steel sections placed for bonding in face-to-face attitude with a suitable viscoelastic core material.

Examples of suitable viscoelastic layer materials are provided above in this specification.

The pre-coat layer should also provide a good substrate for adherence of the viscoelastic core. Excessively low core/precoat interface strength would lead to de-bonding of large areas of the panels, which would compromise both part geometry and damping performance.

To further improve adhesion of the precoat to the galvanized surface, pretreatments can be applied on top of the zinc coatings. These may be similar to the chromate, phosphate, or zirconate conversion coatings that form by reaction of reagents with the metal surface and are used to improve adhesive performance.

To further improve corrosion resistance, sacrificial metal particles can be added to the precoat. These include both Zn particles and Al particles without losing adhesion between the precoat and the metal surface.

Corrosion tests on the interior surfaces of laminate skin materials have been performed following GM's 9 540P corrosion test procedure for steel panels. The salt content of the corrosive solution was increased to 5% to accelerate the corrosion process. Results found that test specimens of commercial laminate skin sheet approximately 0.55 mm thick coated with 60 g/m² of zinc perforated, i.e., corrosion penetration of 0.55 mm, after between 42 and 49 days of exposure. The addition to the zinc coated steel specimens of epoxy pre-coat layers containing zinc particles significantly improved corrosion resistance and test life. Maximum corrosion penetration after 49 days of exposure for similar zinc-coated (60 g/m²) steel material with a pre-coat layer of 2.5 microns was only 0.22 mm while for a 4.5 micrometer thick pre-coat thickness it was even less, only about 0.15 mm.

If the material is required to be resistance spot weldable, conductive particles such as iron phosphide, stainless steel, iron, copper, or nickel can be incorporated within the polymer layers between the sheets. The optimum size for these particles would be approximately the same size or slightly larger than the viscoelastic core thickness. Thinner cores would also improve weldability as they would be easier to displace during the welding operation. The conductivity can be further enhanced by using electrically conductive adhesives, such as those modified with carbon particles, as the precoat materials.

FIG. 2 is a cross-sectional view of a portion of a steel laminate in which another embodiment of the invention is illustrated. In this embodiment electrically conductive particles are incorporated within the viscoelastic core layer of the steel laminate. Referring to FIG. 2, steel laminate 100 comprises thin steel sheets 112 and 114. Surface 118 of steel sheet 112 may have an electrogalvanized or hot dip zinc coating, not illustrated, and has a pre-applied corrosion resistant layer 126. Similarly, surface 122 of steel sheet 114 has a pre-applied corrosion resistant layer 128. A viscoelastic core layer 124 is bonded to each of corrosion resistant layers 126, 128 and joins steel sheets 112 and 114 in assembly of steel laminate 100. Viscoelastic core layer 124 is filled with electrically conductive metal particles 130. Only two conductive particles 130 are shown in FIG. 2 for simplicity of illustration. The average size of the generally spherical particles in this embodiment corresponds to the thickness of the viscoelastic core layer and they are used in suitable quantity and area density (typically about 1% with a range of 0.1% to 10%) to provide at least localized conductivity between steel sheets 112, 114 for a localized resistance spot weld. Although the particles are not embedded in corrosion protection layers 126, 128 in this embodiment, it is expected that they will be harder than these layers and, thus, penetrate layers 126, 128 when electrode pressure is applied to the outer steel layers 112, 114 to form a weld. Of course, in another embodiment of the invention, as illustrated in FIG. 3, the conductive particles may be incorporated in at least selected regions of the non-corrosion layers.

Referring to FIG. 3, steel laminate 200 comprises thin steel sheets 212 and 214. Surface 218 of steel sheet 212 may have a zinc galvanize coating, not illustrated, and has a pre-applied corrosion resistant layer 226. Similarly, surface 222 of steel sheet 214 has a pre-applied corrosion resistant layer 228. A viscoelastic core layer 224 is bonded to each of corrosion resistant layers 226, 228 and joins steel sheets 212 and 214 in assembly of steel laminate 200. In this embodiment, electrically conductive particles 230 are partially embedded in corrosion protection layer 228 extending into viscoelastic core layer 224. They are sized to span the thickness of the viscoelastic core layer 224 and used in area density (typically about 1% with a range 0.1% to 10%) for electrical conductivity between steel sheets 212 and 214.

In one steel laminate 200 preparation embodiment, electrical conductive particles would have been added to the precoat layer 228 prior to application of the viscoelastic core 224. Electrical contact between steel sheets 212, 214 may then be established in two ways. First, during final sheet processing, passing the sheet through rolls (most likely heated) will press the two steel sheets 212, 214 against the particles 230 providing suitable electrical contact. Second, during spot welding, compressive loads applied to the skin sheets by welding electrodes will locally press the two steel sheets 212, 214 against the particles 230 providing electrical contact. Steel laminate 100 may likewise passed through heated rolls to press sheets 112, 114 against particles 130.

In another embodiment of the invention, corrosion resistant light weight structural members are provided. These structural members also include steel skin sheets but the core layer is typically of a light weight fibrous material contributing reinforcing strength to the laminate structure. The cross-sectional appearance of such structural laminates is similar to the arrangement for the vibration damping laminate illustrated in FIG. 1 except the core material is different and the thickness of the steel skins may be greater.

One side or both sides of the steel sheets may be provided with zinc-galvanize protective coating. The facing surfaces of the steel skin sheets are coated with a suitable polymeric corrosion resistant layer selected from the materials described above with respect to the vibration damping laminates. As stated, steel skin layers may be formed, for example, of cold rolled low carbon steel, high strength low alloy steel, bake hardening steel, dual phase steel, or transformation induced plasticity steel. Each steel sheet of the laminate usually has the same thickness and, depending on strength requirements, is typically in the range from 0.10 mm to 1.5 mm.

Many materials may be used in the core layer of structural laminates. These include fibrous sheet materials such a paper cores or other natural fiber cores. In other embodiments, synthetic polymer fibers may be used in the core layer. These fibers include, for example, polyethylene fibers, polyamide fibers or polypropylene fibers. The fiber material may be impregnated with polymer resins including thermosetting resins and thermoplastic resins. Suitable impregnating resins include phenolic resins and polyester resins.

In other embodiments, the core layer may be of a non-fibrous polymer material. Suitable non-fibrous core materials include polyethylene and polypropylene. In some embodiments cross-linked polymers may be preferred for strength at higher temperatures. And it may be preferred to use core polymers grafted with, for example, unsaturated carboxylic acids and/or derivatives for increased bond strength to the corrosion resistant layers of the steel skin layers. An adhesive may be used for increased bond strength between the core and the coated skin layers.

Core thicknesses typically range from about 0.2 mm to about two millimeters.

1. A sheet steel laminate comprising two steel sheets having facing surfaces, the facing surface of each sheet having a polymeric coating layer of a composition for resisting environmental corrosion, and the coated facing surfaces being joined by a core layer.

2. A sheet steel laminate as recited in claim 1 in which the core layer is a vibration damping material.

3. A sheet steel laminate as recited in claim 1 in which the core layer is a vibration damping material, the thickness of each steel sheet being in the range of about one-half millimeter to about one millimeter, the thickness of each polymeric coating layer being in the range of about 0.5 micrometers to about 50 micrometers, and the thickness of the core layer is in the range of abut 5 to about 200 micrometers.

4. A sheet steel laminate as recited in claim 1 in which the core layer is a structural reinforcing layer.

5. A sheet steel laminate as recited in claim 1 in which the core layer is a structural reinforcing layer, the thickness of each steel sheet being in the range of about 0.1 millimeter to about 1.5 millimeters, the thickness of each polymeric coating layer being in the range of about 0.5 micrometers to about 50 micrometers, and the thickness of the core layer is in the range of abut 0.2 millimeters to about 2 millimeters.

6. A sheet steel laminate as recited in claim 1 in which the coating layers comprise an epoxy resin constituent.

7. A sheet steel laminate as recited in claim 1 in which the coating layers comprise an epoxy resin constituent containing dispersed zinc particles and the thicknesses of the coating layers are in the range of about one micron to about five microns.

8. A sheet steel laminate as recited in claim 1 in which the coating layers comprise an epoxy resin constituent which is mixed or co-polymerized with another polymeric material.

9. A vibration damping sheet steel laminate comprising two steel sheets having facing surfaces, the facing surface of each sheet having a coating layer of a composition for resisting environmental corrosion, and the coated facing surfaces being joined by a core layer of a viscoelastic material.

10. A vibration damping sheet steel laminate as recited in claim 9 in which the coating layers comprise particles of a metal composition that is anodic to the composition of the steel sheets.

11. A vibration damping sheet steel laminate as recited in claim 9 in which the coating layers comprise particles of a metal composition that is anodic to the composition of the steel sheets, the particles being of a composition of at least one of zinc, zinc phosphate, magnesium phosphate, calcium phosphate, magnesium phosphite, and calcium phosphite.

12. A vibration damping sheet steel laminate as recited in claim 9 in which the core layer comprises electrically conductive particles.

13. A vibration damping sheet steel laminate as recited in claim 9 in which electrically conductive particles are embedded in at least one of the coating layers and the particles extend into the core layer.

14. A vibration damping sheet steel laminate as recited in claim 12 in which the core layer comprises electrically conductive particles in an area density in the range of about 0.1% to about 10% of the area of contact between the core and coating layers, the size of the electrically conductive particles is substantially the thickness of the core layer, and the particles comprise at least one of iron phosphide particles, stainless steel particles, iron particles, copper particles, and nickel particles.

15. A vibration damping sheet steel laminate as recited in claim 13 in which the size of the electrically conductive particles is substantially the thickness of the core layer.

16. A sheet steel laminate as recited in claim 1 in which the facing surfaces of the steel sheets have a zinc coating applied before application of the corrosion resistant coating layer.

17. A vibration damping sheet steel laminate as recited in claim 6 in which the steel sheets are formed of a carbon steel composition determined for the strength and formability of the sheet steel laminate.

18. A sheet steel laminate as recited in claim 1 in which the overall thickness of the laminate is in the range of about one millimeter to about four millimeters.

19. A sheet steel structural laminate comprising two steel sheets having facing surfaces, the facing surface of each sheet having a coating layer of a composition for resisting environmental corrosion, and the coated facing surfaces being joined by a core layer of reinforcing material having a specific density lower than the density of the steel sheets.

20. A sheet steel structural laminate as recited in claim 19 in which the core material comprises a fibrous polymer.
